(19) United States
(12) Patent Application Publication
(10) Pub. No.: US 2008/0310134 A1
(43) Pub. Date: Dec. 18, 2008

(54) Method and apparatus for routing and distributing signals

(75) Inventors: John W. Curtis, Lakemont, GA (US); Steven E. Miller, Madison, AL (US); Virgil L. Lowe, Roswell, GA (US)

Correspondence Address: BUCHANAN, INGERSOLL & ROONEY PC, POST OFFICE BOX 1404, ALEXANDRIA, VA, 22313-1404, US

(73) Assignee: PESA Switching Systems, Inc., Duluth, GA (US)

(21) Appl. No.: 12/081,210

(22) Filed: Apr. 11, 2008

Related U.S. Application Data
(60) Provisional application No. 60/907,704, filed on Apr. 13, 2007.
(60) Provisional application No. 60/907,726, filed on Apr. 16, 2007.

(51) Int. Cl. H01R 12/16

(52) U.S. Cl. 361/785

(57) ABSTRACT

A method and apparatus are disclosed for distributing multiple signals having audio and/or video components for processing by an audio and/or video processor, including a chassis having a midplane connection and number of slots for receiving plural circuit boards, where at least one of the circuit boards receives a combination of multiple audio and/or video signals via a common slot of the midplane. The midplane is configured to electrically connect to one or more of the plural circuit boards and distribute portions of the multiple signals to plural circuit boards. The midplane has electrical signal interconnects within it for electrically connecting a first one of the plural circuit boards, when inserted into a first one of the slots, to multiple other circuit boards, inserted in other slots. A video signal received from an external device via the first circuit board is supplied to at least one of the circuit boards for video signal processing.

### CROSS REFERENCE TO RELATED APPLICATIONS

This application claims priority under 35 USC §119(e) to U.S. Provisional Application No. 60/907,704, filed on Apr. 13, 2007, and U.S. Provisional Application No. 60/907,726, filed on Apr. 16, 2007, the entire contents of which are hereby incorporated by reference.

### BACKGROUND

Video signals are often distributed to multiple destinations in a television studio, production truck, television broadcast station and other video environments. Video distribution amplifiers have been used for this purpose. Known systems can be large, spread out over several rooms, several floors, different buildings or production trucks, that use many coaxial cables.

The distance that Digital High Definition (HD) TV signals can be distributed over coax cable is limited to about 100 meters. Standard definition (SD) digital signals can be routed 300 meters over the same coaxial cable. This is because HD signals have data rates of 1.485 Gbs as compared to 270 Mbs for SD. The 1080p HD standard and 4:4:4 RGB HD signals require product 3 Gbs data rates as compared to 1.485 Gbs for 1080i, 720p and other HD standards. Distributing 3 Gbs over long distances can be worse than distributing 1.485 Gbs because of the higher frequency. Therefore, the distribution of HD signals involves repeating distribution amplifiers or other techniques to reach distances longer than 100 meters. It is often desirable to locate HD input and/or output devices in various groups throughout a facility. An exemplary large video production or broadcast facility routes camera, remote inputs, graphics generators, video storage and replay devices and other input devices to a large video router. The outputs of the video router are routed to video monitors, editors, production switchers, master control switchers and outer devices that may be located in other areas of the facility.

In addition, the inclusion of router-like and multiplexer-like functions into a signal processing frame is presently unavailable. It is desirable to co-locate circuits having both the features of a router and signal multiplexer in the same chassis or frame.

### SUMMARY

An apparatus is disclosed for distributing signals having audio and/or video components. The apparatus includes a chassis having a midplane connection and a number of slots for receiving plural circuit boards. At least one of the plural circuit boards can receive a combination of multiple audio and/or video signals via a common slot of the midplane. The midplane is configured to electrically connect to a first one of the plural circuit boards, and a second one of the plural circuit boards, and to distribute a first portion of the multiple signals to the first one of the plural circuit boards and another portion of the multiple signals to the second one of the plural circuit boards via the common slot. The midplane has electrical signal interconnects within it for electrically connecting a first one of the plural circuit boards, when inserted into a first one of the slots, to multiple other circuit boards, inserted in other slots. The midplane supplies a video signal received from an external device via the first circuit board to at least one of the circuit boards for video signal processing.

According to an exemplary embodiment, the midplane is configured to electrically connect to each board in the chassis, and the external device is at least one of a router, remote router, and remote processing device. The midplane is configured to receive the video signal from the external device via the first circuit board.

According to an exemplary embodiment, an audio input circuit board is disclosed as being inserted in the chassis and electrically connected to the midplane to provide an audio signal for distribution via the midplane that is provided to the at least one of the circuit boards for video signal processing. The video signal processing embeds the audio signal into the video signal.

The video signal received from an external device via the first circuit board is one of a plurality of video signals de-multiplexed by the first circuit board.

The video signal received from the external device is a multiplexed and modulated optical signal that is de-multiplexed, demodulated and converted to a plurality of electrical signals by the first circuit board.

A method of distributing multiple signals having audio and/or video components within a device for processing by an audio and/or video processor is disclosed. The method includes receiving a video signal from an external device at a first input of a first circuit board inserted in a slot of a chassis having a midplane connection and a number of slots for receiving plural circuit boards. At least one of the plural circuit boards receives a combination of multiple audio and/or video signals via a common slot of the midplane. The midplane is configured to electrically connect to a first one of the plural circuit boards and a second one of the plural circuit boards, and to distribute a first portion of the multiple signals to the first one of the plural circuit boards and another portion of the multiple signals to the second one of the plural circuit boards via the common slot of the midplane. The method also includes supplying the video signal to at least one of the circuit boards for video signal processing via electrical signal interconnects within the midplane that electrically connect the first one of the plural circuit boards, when inserted into a first one of the slots, to multiple other circuit boards, inserted in other slots.

A method of distributing multiple signals having audio and/or video components within a device for processing by an audio and/or video processor is disclosed. The method includes receiving an optical signal from an external device at a first input of a first circuit board inserted in a slot of a chassis having a midplane connection and number of slots for receiving plural circuit boards. At least one of the plural circuit boards receives a combination of multiple audio and/or video signals via a common slot of the midplane. The midplane is configured to electrically connect to a first one of the plural circuit boards and a second one of the plural circuit boards, and to distribute a first portion of the multiple signals to the first one of the plural circuit boards and another portion of the multiple signals to the second one of the plural circuit boards via the common slot of the midplane. The method also includes converting the optical signal into a plurality of high speed electrical signals, and supplying at least one of the plurality of high speed electrical signals to at least one of the circuit boards for video signal processing via electrical signal interconnects within the midplane that electrically connects the first one of the plural circuit boards, when inserted into a first one of the slots, to multiple other circuit boards, inserted in other slots.

### BRIEF DESCRIPTION OF THE DRAWING FIGURES

FIG. 1 shows an exemplary midplane signal distribution from two available genlock reference circuits; the distribution of the genlock reference in groups of three can reduce the number of buffer outputs and traces while maintaining redundancy of genlock reference to all board slots;

FIG. 2 shows an exemplary midplane distribution of the Ethernet control signals; each line represents send and receive pairs from each of the common services board to each of the signal processing boards;

FIG. 3 shows an exemplary high speed signal distribution for midplane connections from slots 1 and 20 to each board, and between adjacent boards from slots 1 through 20;

FIG. 4 shows an exemplary high speed signal distribution for midplane connections from slots 5 and 16 to each board, and between adjacent boards from slots 1 through 20 via slots 5 and 16; and

FIG. 5 shows an exemplary embodiment of a card and its attendant rearplane and midplane connections.

### DETAILED DESCRIPTION

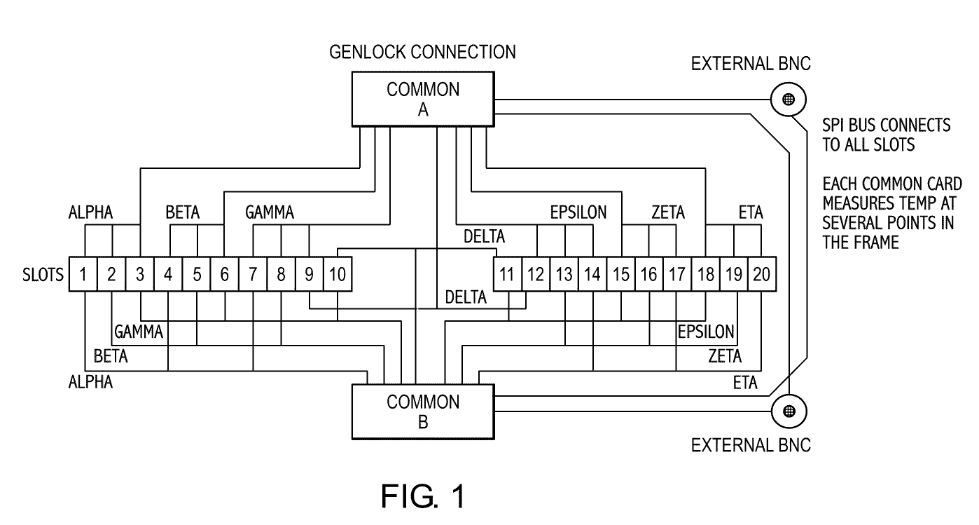

FIG. 1 shows connections of an exemplary midplane to all board slots (1-20) and the “common services board” (Common A and Common B). In this case, each common services board (Common A and Common B) has a microprocessor controller, Ethernet input and Ethernet switch to pass the Ethernet interconnection to every board slot in the chassis and a Genlock reference buffer with distribution to all board slots in groups of three. External BNC connections can be used to input Genlock reference signals, and RJ45 connections allow external communication, either external or internal, to and from the common services boards Common A and/or Common B cards.

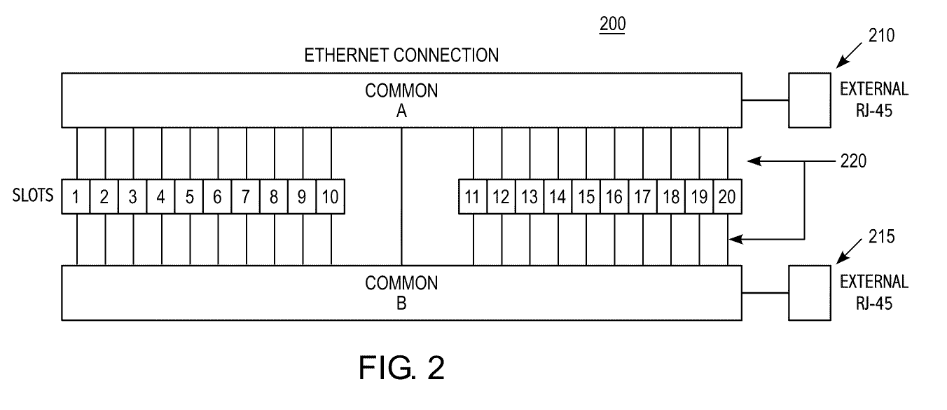

FIG. 2 shows an exemplary midplane distribution of the Ethernet control signals. The configuration 200 has Ethernet inputs 210 and 215 into a back panel that connects with Common A and Common B, respectively. The common services boards provide control and other types of signals to the boards connected to board slots 1-20. Common services board (Common B) can be a redundant services board that can provide redundant signal inputs, in case, board Common A malfunctions or develops a signal error. In the midplane, each line 220 represents send and receive pairs from each of the common services board to each of the signal processing boards; and

An exemplary embodiment uses a combination of Time Domain Multiplexed (TDM) and Coarse Wave Domain Multiplexed (CWDM) techniques to carry multiple video and audio signals between a source, such as a video router, for example, and a remote distribution or processing point. An exemplary chassis can be used at the remote point to receive the multiplexed signals and distribute them throughout the chassis to processing boards or modules. An exemplary midplane that is used in the chassis permits interconnection of multiple high speed signals from input boards that receive many multiplexed signals to the individual processing boards in the chassis and the high speed interconnection between individual boards so that processing can be distributed between two or more PC boards. Exemplary embodiments can route routing HD and 3 Gbs HD signals over the same or longer distances as SD video signals and permit reduction of coaxial cable runs by combining several signals on a single optical fiber. Exemplary embodiments can be scalable to carry video and audio signals to and from as many locations as desired. In addition, exemplary embodiments can allow signal routing within a chassis to be more efficient and easier to use than known point-to-point cable routing, thereby combining the functionality of a router in a chassis that also performs multiplexing/demultiplexing functions.

Exemplary embodiments include a chassis configuration that enables circuit boards to interconnect high speed signals through a midplane saving both I/O (input/output) connectors used to interconnect boards, as well as the labor and cost for making up interconnection cables. An exemplary method of collecting or distributing multiple signals to and from the chassis is also disclosed.

Another feature disclosed herein is directed to a conversion device that converts one or more digital video signals, a collection of digital audio signals or other signals (such as digital control signals) to light by a wideband LED, rather than using a laser to drive a fiber optic cable. Several of the wideband LEDs can be provided and modulated at different optical wavelengths. The multiple wavelengths of modulated light can then be multiplexed onto a single multimode fiber.

The chassis configuration and conversion device can work together to collect and distribute multiple signals from a device (such as a video router) to a remote chassis that is then used to distribute the signals locally to various video devices (such as monitors, transmitters, video compressors, video mixers or production switchers and many other video devices). The chassis can also be used in many other ways such as collecting signals locally, processing them, multiplexing them on a fiber and sending the group of signals to another device such as a video router or another similar chassis.

Additional embodiments allow the chassis to act more efficiently in remotely processing signals that enter the router and need to be processed in some way before being distributed to other video devices. The chassis and multiplexed fiber interconnection allow signals from the router to be sent to the chassis for processing, such as conversion from standard definition to high definition, conversion from one HD format to another, embedding of audio and video from separate sources, color correction or any of the many other video or audio processing functions of a typical video facility, and then send the signals back to the router to be distributed to other devices.

The chassis is designed to also work independently of the router or fiber interconnection to the router and still utilize the multiple forms of interconnections provided by the midplane to house independent boards or build a system of several types of modules in a single or multiple chassis.

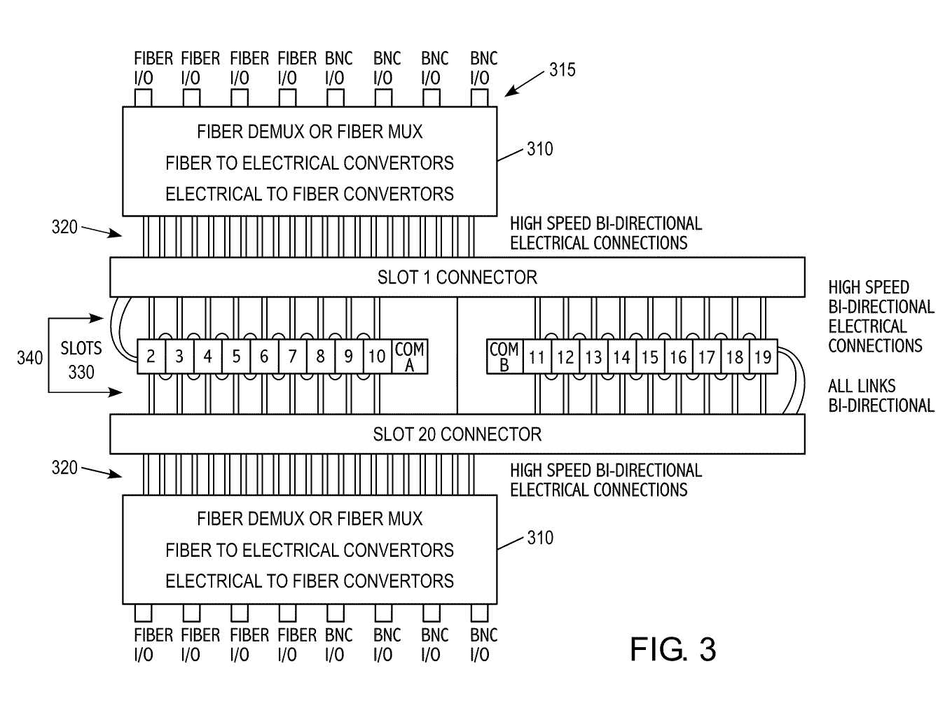

An exemplary embodiment will be described with reference to FIG. 3. The exemplary embodiment has four HD video inputs to four optical fiber modulators (convertors) and an optical fiber multiplexer (MUX) to carry four wide bandwidth HD signals on a single fiber. Four or more fiber inputs and outputs 315 may be used per I/O board 310, which provide the input signals to, in this case, slot 1 via signal paths 320. Of course, other slots can be used. I/O board 310 can have optical signal (fiber) multiplexers (MUX) and de-multiplexers (DEMUX), optical signal (fiber)-to-electrical signal convertors, and electrical signal-to-optical signal (fiber) convertors, or any combination thereof. Signal paths 320 can be, for example, connections to a back panel of a circuit card inserted in a chassis. An exemplary configuration uses sixteen optical modulators and a multiplexer, although any number of modulators and/or multiplexers can be used. For example, additional modulators and/or multiplexers can be used to reduce the number of fiber inputs and outputs required per I/O board. In addition, the wide bandwidth of the optical modulators can be used to Time Division Multiplex (TDM) multiple uncompressed or compressed video signals on each optical wavelength provided by the light source (e.g. LED or laser), such that more signals are multiplexed on a single fiber.

A chassis used in a first exemplary embodiment has twenty board slots 330 with board slots 1 and 20 connected to all other board slots by two bidirectional differential traces. High speed, bidirectional differential pairs of traces 340 from slot 1 to every other board slot 2-20 and another set of differential pairs of traces 340 from slot 20 to every other board slot 1-19 can be provided. One pair can be used to transmit signals while the other pair can be used to receive signals, but this can change to both receive or both transmit on an application-by-application basis since the pairs of signal traces are passive and bidirectional.

The center slots or other board slots can be used as well as the end slots for star routing of the high speed signals. The above described architecture makes use of the end slots easier to route in this particular embodiment.

In addition, signal processing board slots 2 through 19 can be interconnected to adjacent slots on each side by two bidirectional high speed differential pairs of traces to the board slot on the left and two more on the right so that boards can be interconnected without using rear panel Bayonet Neill Concelman (BNC) connectors 315.

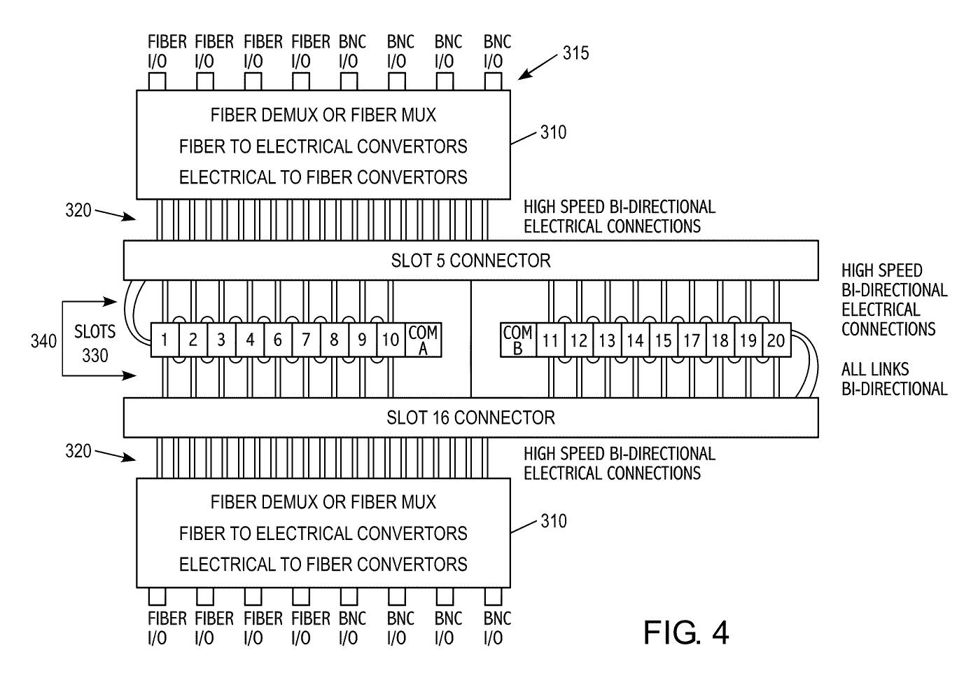

The configuration of FIG. 4 illustrates an exemplary embodiment in which other board slots can be used. As shown in FIG. 4, high speed, bidirectional differential pairs of traces 340 from slot 5 to every other board slot 1-4 and 6-20 and another set of differential pairs of traces 340 from slot 16 to every other board slot 1-15 and 17-20 can be provided. Other than the slots 5 and 16 being used to connect to the board slots, the exemplary configuration of FIG. 4 provides the aforementioned and subsequently described advantageous features of the configuration illustrated in FIG. 3.

Exemplary embodiments can be used in a video production or transmission facility. For example, a multiplexed collection of high speed uncompressed or compressed video signals is sent from a video router to a remote distribution chassis by multiplexing the signals using the technique(s) of CWDM and/or TDM on a fiber and sending it to the remote chassis. With reference to the exemplary embodiment illustrated in FIG. 3, a fiber interface board, such as board 310, is loaded or inserted in slot 1 and several video distribution amplifiers (DAs) are loaded in slots 2 through 19. Similarly, with reference to the exemplary embodiment illustrated in FIG. 4, a fiber interface board, such as board 310, is loaded or inserted in slot 5 and several DAs are loaded in slots 1-4 and 6-20. The signals are demultiplexed, and DAs provide amplified multiple copies of each video signal to the remote location for distribution. These embodiments provide a combination of multiplexing/demultiplexing functionality with the distribution amplification function within a single chassis or frame.

Using a remote DA with a multiplexed fiber connection from the video router to the remote chassis can allow for a greater distance in separation from the router to the point where the signals are to be used, and can reduce the number of coaxial cables used for interconnection. This can reduce cost, labor and space requirements. Also, by using the midplane to input signals to the DA board, a rear panel BNC connector can be saved so that the space can be used as an additional output. At times, using a BNC connector as an additional output, for instance, out of the rear of a card, rather than as an input, can save adding an additional DA board.

Exemplary embodiments can be used to perform more complex signal processing remotely from the router by putting the signal processing boards in the unique chassis and interconnecting them by a multiplexed fiber. For example, sixteen video signals are multiplexed using CWDM and/or TDM using known techniques on one or more fibers and sent to slot 1 in the chassis, while 256 or more audio signals are multiplexed using TDM on a fiber or Gig E cable and sent to slot 20. A video router can be used for the video sources, while a DRS or TDM audio router, for example, can be used for the audio sources.

In another embodiment, a fiber input board is loaded in slot 1 in the chassis where the multiplexed signals are de-multiplexed, converted back to electrical signals and sent over the midplane to the signal processing boards loaded in slots 2 through 19. The signal processing boards in slots 2 through 19 in the chassis may receive one or more video signals from the fiber interface board in slot 1, and sixteen or more audio signals from the interface board in slot 20. The processing boards then combine the audio and video signals by embedding up to sixteen of the audio signals on each video signal. The embedding video signals can be sent back to slot 1 or slot 20 from all of the embedder processing boards on the second set of traces and multiplexed on fiber so the multiplexed video signals can be sent back to the router or other remote device. This use of the chassis allows the Video Router and DRS or TDM Audio Router to be integrated in a system rather than standing alone. Each of the processing boards also has a BNC output connector to output the embedded signal on a known coaxial cable. These advantageous features can be similarly provided with the exemplary configuration illustrated in FIG. 4.

For comparison, a known chassis used in the video industry receives individual fiber or coaxial signals to each board slot independently. An audio/video embedder processing board can have independent audio and video inputs and outputs from rear panel BNC connectors.

In accordance with exemplary embodiments, signals can be collected and multiplexed onto an optical fiber, and distributed over longer distances to a remote point where they can be converted to electrical signals, processed as desired and distributed locally over less expensive coaxial cable. Larger systems can be built up using several of the chassis described herein to create multiple signal collection points and receiving points that may be interconnected by a video router and/or audio router.

Exemplary embodiments can also reduce the number of coaxial cables that are used to distribute video signals throughout a large facility to destinations where they are needed. Known systems use multiple coaxial cables that involve large cable trays with a high cost of installation to connect source devices to a central video router. Multiple coaxial cables can be used to connect signals from the video router to the devices where they are used or displayed. Repeaters or distribution amplifiers can be used at one or more points in the cable run to distribute HD signals over long distances.

Another known system modulates a single HD or SD signal on a single fiber and transmits the modulated signal long distances to a receiving end where the modulated signal is converted back to an electrical signal. However, this system can include separate fibers for each signal and a separate optical-to-electrical conversion device at each destination point.

Another type of board that can be installed in the chassis to provide a different type of external or remote video and/or audio processing device receives one or more video signals embedded with audio or other signals through the midplane from either slot 1 or 20 in the exemplary embodiment of FIG. 3, of from either slot 5 or 16 in the exemplary embodiment of FIG. 4, de-embeds the audio from the video, processes the audio and/or video for video gain, saturation, hue, color attributes and black level, processes the audio for gain, phase, delay or other attributes, and re-embeds the audio in the video signal. The processed, embedded signal can then be sent back to the router or distributed locally through the BNC connectors on the rear panel of the processing boards. Audio and/or video signals need not be embedded, but can be processed in a similar way.

More complex boards are also available that can provide various forms of video and/or audio processing such as mixing and keying of several signals to boards that convert video signals from one format to another, such as converting NTSC or standard definition 480i/59.94 video to 720p/59.94 to 1080i/59.94 HD formats, for example. Any type of format conversions can be provided.

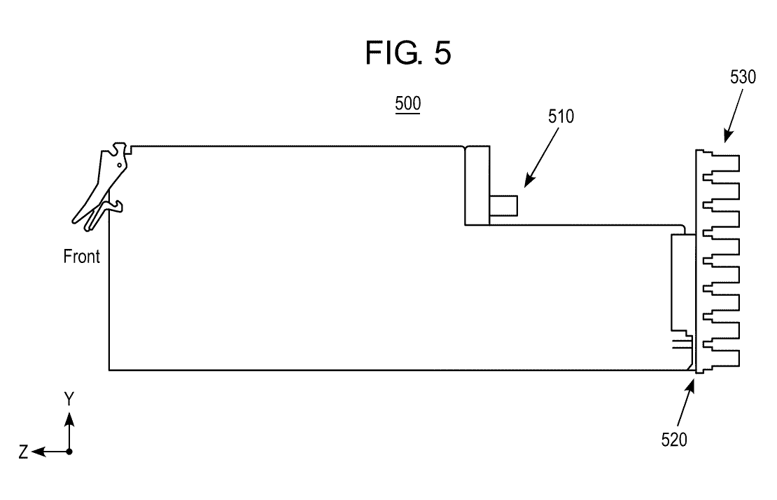

FIG. 5 illustrates an exemplary circuit card. The back of the card 500 can have up to eight inputs/outputs 530 in any number or combination. The types of cables that can be connected can be either coaxial, Ethernet or fiber optic or other suitable transmission media connectors. For example, the exemplary circuit card of FIG. 5 can have three coaxial cable inputs and five fiber optic outputs, or three fiber optic inputs, one fiber optic output and four coaxial outputs. The configurations of the inputs/outputs are determined on an application-by-application basis. The midplane connection can be via 100 ohm differential signaling for each board. The input signals and output signals can be provided via back panel 520 to the circuit board 500. Back panel 520 is provided on each board 500, and can have a 75 ohm multi-pin connection. However, each board 500 inserted in a slot may not have inputs/outputs 530 or back panel 520. The front of the card can also have inputs and outputs similar to the front of the card.

The midplane connector allows distribution of the signals input via the circuit cards installed in slots 1 and 20, as shown in FIG. 1, to each of boards in slots 2-19. This reduces the number of cable connections necessary to distribute such signals and also makes outputs and inputs available that would otherwise be used to distribute the signals from slots 1 and 20 to slots 2-19. The same advantageous features can be obtained in the exemplary configuration illustrated in FIG. 4, in which the midplane connector allows distribution of the signals input via the circuit cards installed in slots 5 and 16 to each of boards in slots 14, 6-15 and 17-20.

Additionally, the described embodiments allow a circuit card in one slot, for instance, slot 3, to monitor the quality or integrity of signals, local routing and cross connection or any combination thereof on circuit cards in the other slots, e.g., slots 1, 2, 4-20, or a subset thereof, in the chassis or frame.

Exemplary embodiments can be used in various ways to combine the capabilities of a video router and processing boards that can be installed in the disclosed chassis to achieve the functions desired in a video production or transmission facility, for example, in a more efficient and less costly way than known signal processing chassis and boards.

While the exemplary embodiments have been particularly described with reference to the various drawings, it is to be understood that the drawings and exemplary embodiments are provided for illustration only and should not be construed as limiting the scope of the present disclosure.

It will be appreciated by those skilled in the art that the present invention can be embodied in other specific forms without departing from the spirit or essential character thereof. The presently disclosed embodiments are considered in all respects to be illustrative and not restrictive. The scope of the present disclosure is indicated by the appended claims rather than the foregoing description, and all changes that come within the meaning and range of equivalents thereof are indicated to be embraced therein.

What is claimed is:

1. An apparatus for distributing multiple signals having audio and/or video components for processing by an audio and/or video processor, comprising:
a chassis having a midplane connection and a number of slots for receiving plural circuit boards, at least one of the plural circuit boards receiving a combination of multiple audio and/or video signals via a common slot of the midplane, wherein the midplane is configured to electrically connect to a first one of the plural circuit boards and a second one of the plural circuit boards, and to distribute a first portion of the multiple signals to the first one of the plural circuit boards and another portion of the multiple signals to the second one of the plural circuit boards via the common slot; and
electrical signal interconnects within the midplane for electrically connecting the first one of the plural circuit boards, when inserted into a first one of the slots, to multiple other circuit boards, inserted in other slots, such that a video signal received from an external device via the first circuit board is supplied to at least one of the circuit boards for video signal processing.

2. The apparatus of claim 1, wherein the midplane is configured to electrically connect to each board in the chassis, and the external device is at least one of a router, remote router, and processing device.

3. The apparatus of claim 2, wherein the midplane is configured to receive the video signal received from the external device via the first circuit board.

4. The apparatus of claim 2, comprising:
an audio input circuit board inserted in the chassis and electrically connected to the midplane to provide an audio signal for distribution via the midplane that is provided to the at least one of the circuit boards for video signal processing, wherein the video signal processing embeds the audio signal into the video signal.

5. The apparatus of claim 1, wherein the video signal received from an external device via the first circuit board is one of a plurality of video signals de-multiplexed by the first circuit board.

6. The apparatus of claim 1, wherein the video signal received from the external device is a multiplexed and modulated optical signal, and the first circuit board is configured to de-multiplex, demodulate and convert the video signal received from the external device to a plurality of electrical signals.

7. A method of distributing multiple signals having audio and/or video components within a device for processing by an audio and/or video processor, comprising:
receiving a video signal from an external device at a first input of a first circuit board inserted in a slot of a chassis having a midplane connection and a number of slots for receiving plural circuit boards, at least one of the plural circuit boards receiving a combination of multiple audio and/or video signals via a common slot of the midplane, wherein the midplane is configured to electrically connect to a first one of the plural circuit boards and a second one of the plural circuit boards, and to distribute a first portion of the multiple signals to the first one of the plural circuit boards and another portion of the multiple signals to the second one of the plural circuit boards via the common slot of the midplane; and
supplying the video signal to at least one of the circuit boards for video signal processing via electrical signal interconnects within the midplane that electrically connect the first one of the plural circuit boards, when inserted into a first one of the slots, to multiple other circuit boards, inserted in other slots.

8. A method of distributing multiple signals having audio and/or video components within a device for processing by an audio and/or video processor, comprising:
receiving an optical signal from an external device at a first input of a first circuit board inserted in a slot of a chassis having a midplane connection and a number of slots for receiving plural circuit boards, at least one of the plural circuit boards receiving a combination of multiple audio and/or video signals via a common slot of the midplane, wherein the midplane is configured to electrically connect to a first one of the plural circuit boards and a second one of the plural circuit boards, and to distribute a first portion of the multiple signals to the first one of the plural circuit boards and another portion of the multiple signals to the second one of the plural circuit boards via the common slot of the midplane;
converting the optical signal into a plurality of high speed electrical signals; and
supplying at least one of the plurality of high speed electrical signals to at least one of the circuit boards for video signal processing via electrical signal interconnects within the midplane that electrically connect a first one of the plural circuit boards, when inserted into the first one of the slots, to multiple other circuit boards, inserted in other slots.
